(19) United States
(12) Patent Application Publication
(10) Pub. No.: US 2005/0286957 A1
(43) Pub. Date: Dec. 29, 2005

(54) THERMAL PRINTER CAPABLE OF AVERTING INDENTATION OF PAPER AND WITHDRAWING PAPER SMOOTHLY

(76) Inventor: Chi-Chan Chiang, Taipei City (TW)

Correspondence Address: NORTH AMERICA INTELLECTUAL PROPERTY CORPORATION, P.O. BOX 506, MERRIFIELD, VA, 22116, US

(21) Appl. No.: 10/711,513

(22) Filed: Sep. 23, 2004

(30) Foreign Application Priority Data
Jun. 29, 2004 (TW) 093119167

(51) Int. Cl. B41J 13/02

(52) U.S. Cl. 400/641

(57) ABSTRACT

A thermal printer includes a capstan roller, a pinch roller for pressing a print medium to the capstan roller, and bushing installed around the pinch roller. The outer radius of the bushing is greater than the radius of the pinch roller so that there is a gap between the capstan roller and the pinch roller. The thermal printer further includes a pinch roller driving device for pressing the pinch roller onto the print medium or separating the pinch roller from the print medium.

### BACKGROUND OF INVENTION

1. Field of the Invention

The present invention relates to a thermal printer and more particularly, to a thermal printer capable of adjusting the distance between a capstan roller and a pinch roller so as to optimize print quality and solve paper-jamming problems.

2. Description of the Prior Art

Please refer to FIG. 1. FIG. 1 is diagram of a paper-feeding mechanism of a conventional thermal printer 10. The paper-feeding mechanism of the thermal printer 10 includes a capstan roller 12 and a pinch roller 14. There are two pricking areas 16 on the two ends of the capstan roller 12, and there is a plurality of prickers 18 on the surface of the pricking area 16. A paper 20 can pass through the gap between the capstan roller 12 and the pinch roller 14, such that the pinch roller 14 can press the paper 20 to the capstan roller 12, and the plurality of prickers 18 of the pricking areas 16 can pierce the fibers of the paper 20 so that the paper 20 can be held firmly and moved forward and backward for printing. There are two rubber sheaths 22 sheathing the two ends of the pinch roller 14 at positions relative (??corresponding??) to the two pricking area 16 on the capstan roller 12. The rubber sheaths 22 prevent potential damage to the prickers 18 and the pinch roller 14 due to the prickers piercing the paper 20 and coming into direct contact with the pinch roller 14.

Please refer to FIG. 2. FIG. 2 illustrates the capstan roller 12 and pinch roller 14 of the thermal printer 10 holding the paper 20. As shown in FIG. 2, the distance between the capstan roller 12 and the pinch roller 14 is constant. Consequently, in cases where the paper 20 is too thick, the capstan roller 12 and the pinch roller 14 cannot hold the paper firmly. In opposite cases where the paper 20 is too thin, there is a likelihood of the pricker 18 piercing and damaging the paper 20. In addition, if the pinch roller 14 presses the paper 20 to the capstan roller 12 too heavily, there is a likelihood of the pricker 18 piercing and damaging the paper 20 and the rubber sheath 22 on the pinch roller 14 would make an indentation on the surface of the paper 20. Further, because the distance between the capstan roller 12 and the pinch roller 14 is fixed, it is difficult to withdraw the paper 20 if paper-jamming occurs. So, it can be appreciated then that there are many problems associated with such conventional paper-feeding mechanisms.

### SUMMARY OF INVENTION

It is therefore a primary objective of the claimed invention to provide a thermal printer capable of adjusting the distance between a capstan roller and a pinch roller so as to optimize the print quality and prevent paper-jamming problems.

According to the claimed invention, a thermal printer includes a capstan roller, a pinch roller for pressing a print medium to the capstan roller, and bushing installed around the pinch roller. The outer radius of the bushing is greater than the radius of the pinch roller so that there is a gap between the capstan roller and the pinch roller. The thermal printer further includes a pinch roller driving device for pressing the pinch roller onto the print medium or separating the pinch roller from the print medium.

According to the claimed invention, a thermal printer includes a capstan roller, a pinch roller for pressing a print medium to the capstan roller, and bushing installed around the capstan roller. The outer radius of the bushing is greater than the radius of the capstan roller so that there is a gap between the capstan roller and the pinch roller. The thermal printer further includes a pinch roller driving device for pressing the pinch roller onto the print medium or separating the pinch roller from the print medium.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is diagram of a paper-feeding mechanism of a conventional thermal printer.

FIG. 2 illustrates a capstan roller and a pinch roller of the thermal printer holding paper.

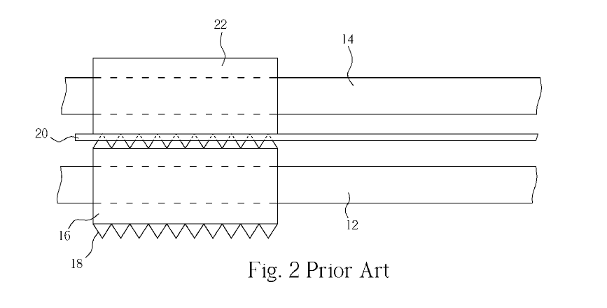

FIG. 3 is a diagram of a paper-feeding mechanism of a thermal printer according to the present invention.

FIG. 4 illustrates a capstan roller and a pinch roller of the thermal printer holding print medium according to the present invention.

FIG. 5 is a diagram of the pinch roller driven so as to separate from the print medium by a pinch roller driving device.

FIG. 6 is a diagram of the pinch roller driven to press the print medium by the pinch roller driving device.

FIG. 7 is a diagram of a paper-feeding mechanism of a thermal printer according to an alternative embodiment of the present invention.

FIG. 8 illustrates the capstan roller and the pinch roller of the thermal printer holding the print medium according to an alternative embodiment of the present invention.

### DETAILED DESCRIPTION

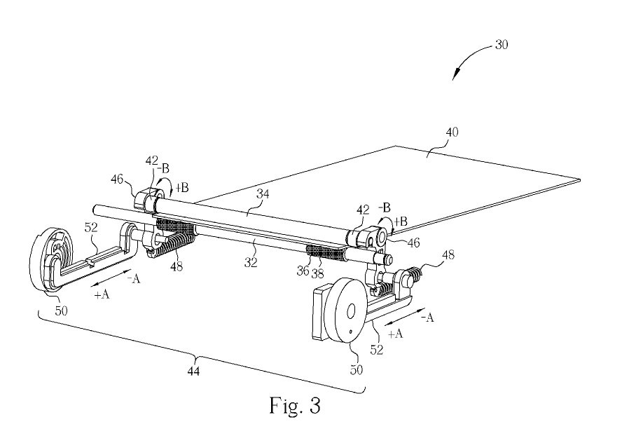

Please refer to FIG. 3. FIG. 3 is a diagram of a paper-feeding mechanism of a thermal printer 30 according to the present invention. The paper-feeding mechanism of the thermal printer 30 is installed inside a housing (not shown in FIG. 3) of the thermal printer 30. The paper-feeding mechanism of the thermal printer 30 includes a capstan roller 32 and a pinch roller 34. There are two pricking areas 36 on the two ends of the capstan roller 32, and there is a plurality of prickers 38 on the surface of the pricking area 36. A print medium 40 can pass through the gap between the capstan roller 32 and the pinch roller 34, whereupon the pinch roller 34 can press the print medium 40 to the capstan roller 32, and the plurality of prickers 38 on the pricking areas 36 can pierce the fibers of the print medium 40 so that the print medium 40 can be held firmly and moved forward and backward for printing. The print medium 40 can be photo paper intended for use in thermal printers.

The thermal printer 30 further includes two bushes 42 one installed at each end of the pinch roller 34. The outer radius of each of the bushes 42 is greater than the radius of the pinch roller 34, so that there is an appropriate gap between the center axis of the capstan roller 32 and the center axis of the pinch roller 34. The bushes 42 can be formed as separate components, these components being fixed to the pinch roller 34, or alternatively formed as integral parts of the pinch roller 34. In addition, the inward facing (relative to the pinch roller 34) edges of the bushes 42 are positioned, i.e. suitable spaced apart on the pinch roller 34, so as to clear the outer edges of the print medium 40. Hence the bushes 42 cannot affect the feeding motion of the paper medium 40 between the capstan roller 32 and the pinch roller 34.

The thermal printer 30 further includes a pinch roller driving device 44 for pressing the pinch roller 34 onto the print medium 40, or for separating the pinch roller 34 from the print medium 40. The pinch roller driving device 44 includes a pair of levers 46 connected to the pinch roller 34 for driving the pinch roller 34, a pair of springs 48, one each connected to each of the pair of levers 46, for providing elastic force to the levers 46. The springs 48 act so as to control the holding force between the capstan roller 32 and the pinch roller 34. The pinch roller driving device 44 also includes a pair of cams 50, for controlling the position of the pinch roller 34, and a pair of drag links 52 connecting each of the levers 46 to one of the pair of cams 50. The drag links 52 transfer linear movement generated by the cams 50 to the pinch roller driving levers 46. The pinch roller driving device 44 is not limited to the above-mentioned mechanism, and the present invention includes any mechanism capable of pressing the pinch roller 34 onto the print medium 40 or separating the pinch roller 34 from the print medium 40.

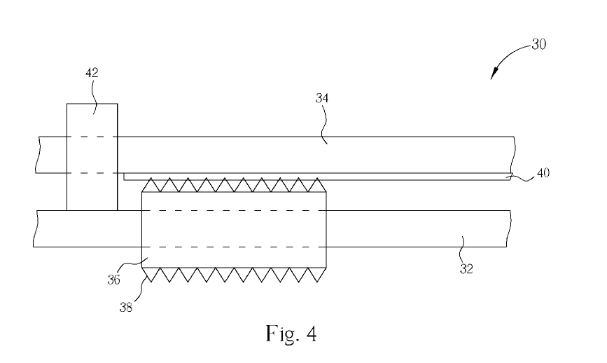

Please refer to FIG. 4. FIG. 4 illustrates the capstan roller 32 and the pinch roller 34 of the thermal printer 30 holding the print medium 40 according to the present invention. As shown in FIG. 4, the outer radius of the bushes 42 installed around the pinch roller 34 are greater than the radius of the pinch roller 34, and as mentioned above, the inner edges of the bushes 42 are positioned outside the outer edges of the print medium 40. The distance between the center axis of the capstan roller 32 and the center axis of the pinch roller 34 is dependent on the size of the bushes 42. So the bushes 42 can be selected according to the nominal thickness of paper medium 40 intended for use in the printer. When the paper medium 40 is thin, smaller bushes 42 can be selected so that the gap between the capstan roller 32 and the pinch roller 34 is proportionally smaller and the capstan roller 32 and the pinch roller 34 can hold the paper medium 40 firmly. When the paper medium 40 is thick, larger bushes 42 can be selected so that the gap between the capstan roller 32 and the pinch roller 34 is proportionally larger and the prickers 38 will not pierce and damage the print medium 40. In conclusion, the distance between the capstan roller 32 and the pinch roller 34 can be optimized by selecting the dimensions of the bushes 42 according to the print media 40.

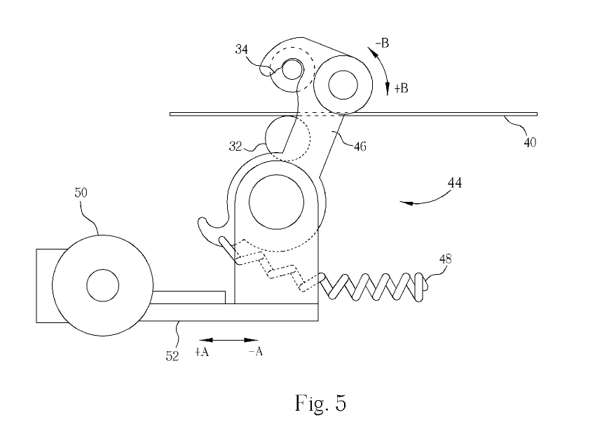

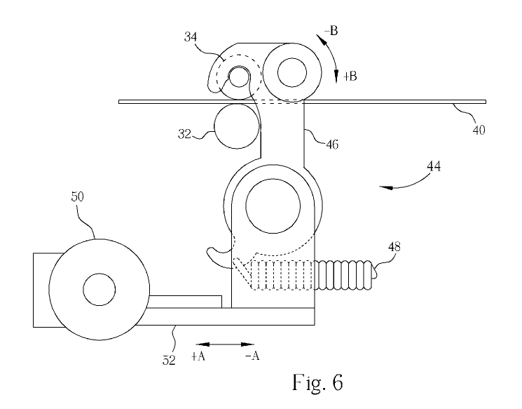

Please refer to FIG. 5 and FIG. 6. FIG. 5 is a diagram of the pinch roller 34 driven to separate from the print medium 40 by the pinch roller driving device 44. FIG. 6 is a diagram of the pinch roller 34 driven to press the print medium 40 by the pinch roller driving device 44. When the print medium 40 jams inside the thermal printer 30, a user can rotate the cams 50 of the pinch roller driving device 44 in order to move the drag links 52 in the +A direction. This action will rotate the levers 46 in the +B direction, in doing so resisting elastic forces generated by the springs 48, so as to separate the pinch roller 34 from the print medium 40. At that time the user can withdraw the print medium 40. When the user releases or counter-rotates the cams 50 of the pinch roller driving device 44, thus causing the drag links 52 to move in the −A direction, the levers 46 will rotate in the −B direction and, at the same time, the pinch roller 34 will press the print medium 40 onto the capstan roller 32 assisted by restoring forces generated by the springs 48 so as to firmly hold the print medium 40.

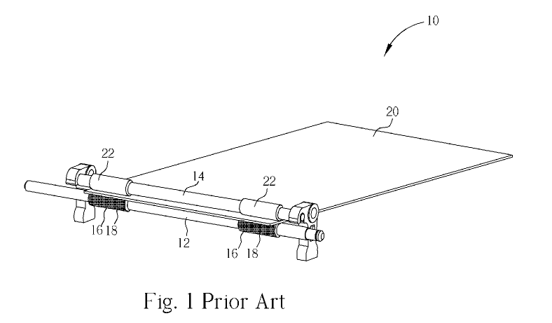

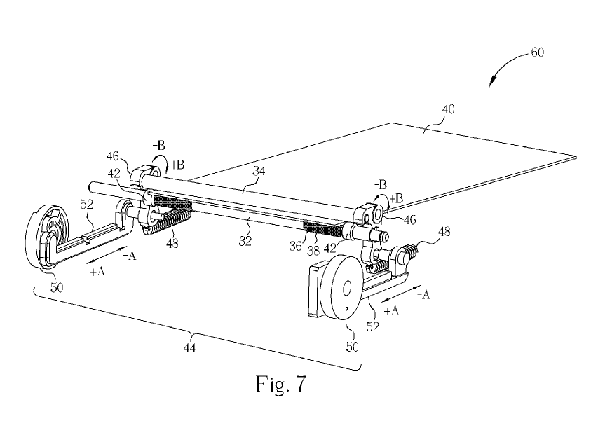

Furthermore, the bushes 42 also can be installed around the capstan roller 32 instead of around the pinch roller 34. Please refer to FIG. 7. FIG. 7 is a diagram of a paper-feeding mechanism of a thermal printer 60 according to another embodiment of the present invention. The elements with the same numerals in FIG. 7 and FIG. 1 have the same structure and function. The difference between the thermal printer 60 and the thermal printer 30 is the position of the bushes 42. As shown in FIG. 7, the bushes 42 are installed around the capstan roller 32, and the outer radius of each of the bushes 42 is greater than the radius of the capstan roller 32 so that there is an appropriate gap between the center axis of the capstan roller 32 and the center axis of the pinch roller 34. The bushes 42 can be formed as separate components, these components being fixed to the capstan roller 32, or alternatively formed as integral parts of the capstan roller 32. In addition, the inward facing edges of the bushes 42 are positioned, i.e. suitably spaced apart, to clear the outer edges of the print medium 40. Hence the bushes 42 cannot affect the motion of the paper medium 40 between the capstan roller 32 and the pinch roller 34.

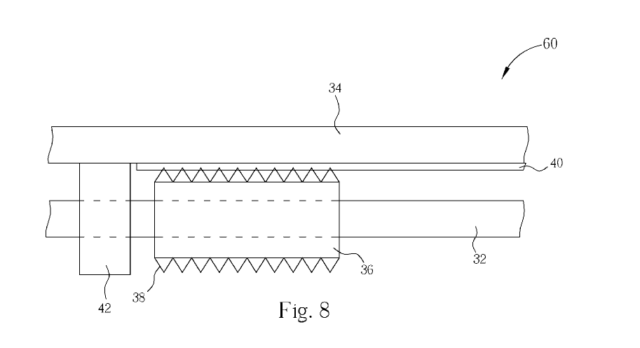

Please refer to FIG. 8. FIG. 8 illustrates the capstan roller 32 and the pinch roller 34 of the thermal printer 60 holding the print medium 40. As shown in FIG. 8, the outer radius of each of the bushes 42 installed around the capstan roller 32 is greater than the radius of the capstan roller 32, and as mentioned above, the inner edges of the bushes 42 are positioned outside the outer edges of the print medium 40. The distance between the center axis of the capstan roller 32 and the center axis of the pinch roller 34 is dependent on the size of the bushes 42. So, as with the previously described embodiment, the bushes 42 can be selected according to the nominal thickness of paper medium 40 intended for use in the printer. When the paper medium 40 is thin, smaller bushes 42 can be selected so that the gap between the capstan roller 32 and the pinch roller 34 is proportionally smaller and the capstan roller 32 and the pinch roller 34 can hold the paper medium 40 firmly. When the paper medium 40 is thick, larger bushes 42 can be selected so that the gap between the capstan roller 32 and the pinch roller 34 is proportionally larger and the prickers 38 will not pierce and damage the print medium 40. In conclusion, the distance between the capstan roller 32 and the pinch roller 34 can be optimized by selecting the dimensions of the bushes 42 according to the print media 40.

Compared to the conventional thermal printer, the bushes can be installed around the pinch roller or the capstan roller of the thermal printer in the present invention. And the distance between the capstan roller and the pinch roller can be optimized by selecting the dimensions of the bushes according to the nominal thickness of intended print media. Furthermore, the described pinch roller driving device can solve paper-jamming problems effectively.

Those skilled in the art will readily observe that numerous modifications and alterations of the device may be made while retaining the teachings of the invention. Accordingly, the above disclosure should be construed as limited only by the metes and bounds of the appended claims.

1. A thermal printer comprising:
a capstan roller;
a pinch roller for pressing a print medium to the capstan roller;
bushing installed around the pinch roller, wherein the outer radius of the bushing is greater than the radius of the pinch roller so that there is a gap between the capstan roller and the pinch roller; and
a pinch roller driving device for pressing the pinch roller onto the print medium or separating the pinch roller from the print medium.

2. The thermal printer of claim 1 wherein a plurality of prickers is positioned on the surface of the capstan roller for pricking the print medium.

3. The thermal printer of claim 1 wherein the bushing is sheathed on the pinch roller.

4. The thermal printer of claim 1 wherein the inner edges of the bushing are positioned outside the outer edges of the print medium.

5. The thermal printer of claim 1 wherein the pinch roller driving device comprises:
a lever connected to the pinch roller for driving the pinch roller;
a spring connected to the lever for providing an elastic force to the lever;
a cam; and
a drag link connected to the lever and the cam for transferring a travel of the cam to a travel of the lever.

6. A thermal printer comprising:
a capstan roller;
a pinch roller for pressing a print medium to the capstan roller;
bushing installed around the capstan roller, wherein the outer radius of the bushing is greater than the radius of the capstan roller so that there is a gap between the capstan roller and the pinch roller; and
a pinch roller driving device for pressing the pinch roller onto the print medium or separating the pinch roller from the print medium.

7. The thermal printer of claim 6 wherein a plurality of prickers is positioned on the surface of the capstan roller for pricking the print medium.

8. The thermal printer of claim 6 wherein the bushing is sheathed on the capstan roller.

9. The thermal printer of claim 6 wherein the inner edges of the bushing are positioned outside the outer edges of the print medium.

10. The thermal printer of claim 6 wherein the pinch roller driving device comprises:
a lever connected to the pinch roller for driving the pinch roller;
a spring connected to the lever for providing an elastic force to the lever;
a cam; and
a drag link connected to the lever and the cam for transferring a travel of the cam to a travel of the lever.
